(19) United States
(12) Patent Application Publication
(10) Pub. No.: US 2005/0115654 A1
(43) Pub. Date: Jun. 2, 2005

(54) Elastic tie-down strap with snap hooks for attaching tire chains to tires

(76) Inventor: James B. Badham, Hobart, WA (US)

Correspondence Address: KENNETH W. MOODY, 2136 7TH AVE SW, PUYALLUP, WA, 98371, US

(21) Appl. No.: 10/722,519

(22) Filed: Nov. 28, 2003

(51) Int. Cl. B60C 11/00

(52) U.S. Cl. 152/231

(57) ABSTRACT

The elastic tie-down strap with snap hooks for attaching tire chains to tires is an elongated elastic member with an aperture in each of its two ends and a third aperture in its segment that extends between the two ends. Three snap hooks are coupled with the elongated elastic member via the apertures, with each snap hook passing through a separate aperture. When the snap hooks of a pair of the device are attached to points on a set of tire chains that is wrapped around a tire such that each elongated elastic member forms a two-legged angle with each leg stretched and in tension, the pair of the device secures the set of tire chains tightly to the tire. In an alternative embodiment, the elongated elastic member has just two apertures, one in each of its two ends with a separate snap hook passing through each aperture.

### BACKGROUND OF THE INVENTION

1. Field of the Invention

The present invention relates to tie-down straps, and more particularly to a tie-down strap adapted to secure tire chains to the tires of an automobile or truck in a manner that is both quick and safe.

2. Description of the Related Art

In parts of the country where snow and ice collect on roadways, tire chains are often used to improve the safety and control of automobiles and trucks. Typically, a set of tire chains is wrapped around the circumference of each tire and secured tightly to the tire by two bungee cords attached to the inner circular portion of the chains such that the bungee cords are perpendicular to each other, as shown in FIG. 1. Although helpful overall, tire chains secured to tires in this manner have several known drawbacks. First, because the bungee cords cross over each other, they are subject to constant chafing and failure. Second, when a bungee cord does fail, i.e. break, the fragments of the cord typically snap free of the tire chains, presenting a danger of injury to nearby persons and littering a roadway. Third, when used to secure chains to a large tire such as one on a truck, two bungee cords with four points of restraint typically are not adequate. In such circumstances three cords, with six points of restraint, are more appropriate, but an added bungee cord increases chafing and the risk of a failure. Fourth, when not being used with the chains, the bungee cords are awkward to handle and store due to their open hooks, which often become entangled.

In light of the above, an improved means for securing tire chains to the tires of automobiles and trucks is needed.

U.S. Pat. No. 1,320,916, issued Nov. 4, 1919 to J. L. Randolph; U.S. Pat. No. 1,339,963, issued May 11, 1920 to C. E. Mahan; U.S. Pat. No. 1,473,797, issued Nov. 13, 1923 to L. B. Servis; U.S. Pat. No. 1,758,994, issued May 20, 1930 to C. E. Grosch; and U.S. Pat. No. 2,820,502, issued Jan. 21, 1958 to R. C. Spencer provide examples of tire chain devices which employ either restraints with open hooks or complex fastening means.

U.S. Pat. Pub. No. U.S. 2001/0001340, published May 24, 2001; U.S. Pat. No. 4,769,875, issued Sep. 13, 1988 to D. E. Hartman; U.S. Pat. No. 5,050,924, issued Sep. 24, 1991 to G. G. Hansen; U.S. Pat. No. 5,623,750, issued Apr. 29, 1997 to J. A. Nasin et al.; U.S. Pat. No. 5,673,464, issued Oct. 7, 1997 to M. Whittaker; U.S. Pat. No. 5,682,652, issued Nov. 4, 1997 to S. D. Brody et al.; and U.S. Pat. No. 6,014,794, issued Jan. 18, 2000 to P. M. McCoy each discloses an elastic cord with at least one open hook.

U.S. Pat. Pub. No. U.S. 2003/0093884, published May 22, 2003; U.S. Pat. Pub. No. U.S. 2003/0097736, published May 29, 2003; U.S. Pat. No. 2,372,967, issued Apr. 3, 1945 to J. S. Martin; U.S. Pat. No. 5,159,729, issued Nov. 3, 1992 to W. T. Walker; U.S. Pat. No. 5,440,790, issued Aug. 15, 1995 to A. Chou; and U.S. Pat. No. 6,038,745, issued Mar. 21, 2000 to D. M. Rapp each discloses a non-elastic strap with at least one open or clip hook.

U.S. Pat. No. 5,797,167, issued Aug. 25, 1998 to L. M. Schwab discloses a tie down device incorporating a pair of elastic cords, a keeper element and an attachment means in the nature of a hook.

None of the above inventions and patents is seen to describe the instant invention as claimed. Thus, an elastic tie-down strap solving the aforementioned problems is desired.

### SUMMARY OF THE INVENTION

The elastic tie-down strap with snap hooks for attaching tire chains to tires is an elongated elastic member with an aperture in each of its two ends and a third aperture in the segment that extends between the two ends. Three snap hooks are coupled with the elongated elastic member via the apertures, with each snap hook passing through a separate aperture. When the snap hooks of a pair of the devices are attached to points on a set of tire chains that is wrapped around a tire such that each elongated elastic member forms a two-legged angle with each leg stretched and in tension, the pair of devices secures the set of tire chains tightly to the tire.

In an alternative embodiment, the elongated member has just two apertures, one in each of its two ends with a separate snap hook passing through each aperture.

Accordingly, it is a principal object of the invention to provide an elastic tie-down strap for quickly and safely securing a set of tire chains to a tire.

It is another object of the invention to provide an elastic tie-down strap for securing a set of tire chains to a tire that, when used in pairs, do not cross over each other, thereby avoiding chaffing and reducing the likelihood of breakage.

It is a further object of the invention to provide an elastic tie-down strap for securing a set of tire chains to a tire that, when used in pairs, attach to six points on the inner circular portion of a set of tire chains to pull the set of chains more tightly onto the tire.

Still another object of the invention is to provide an elastic tie-down strap for securing a set of tire chains to a tire that have snap hooks instead of open ended S-hooks so that, in the event of breakage, the fragments of the device remain attached to the tire chains and thus neither litter roadways nor present a danger of injury to persons by snapping free from a tire chain.

It is an object of the invention to provide improved elements and arrangements thereof for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is a perspective view of a prior art tie-down strap shown securing a set of tire chains to a tire.

FIG. 2 is a perspective view of an elastic tie-down strap with snap hooks for attaching tire chains to a tire according to the present invention shown securing a set of tire chains to a tire.

FIG. 3 is a perspective view of an elastic tie-down strap with snap hooks for attaching tire chains to a tire according to the present invention.

FIG. 4 is an exploded, perspective view of an elastic tie-down strap with snap hooks for attaching tire chains to a tire according to the present invention.

FIG. 5A is a top view of an elongated elastic member for an elastic tie-down strap with snap hooks for attaching tire chains to a tire according to the present invention.

FIG. 5B is an elevational side view of an elongated elastic member for an elastic tie-down strap with snap hooks for attaching tire chains to a tire according to the present invention.

FIG. 6 is a perspective view of an alternative embodiment of an elastic tie-down strap with snap hooks for attaching tire chains to a tire according to the present invention shown securing a set of tire chains to a tire.

FIG. 7 is a perspective view of an alternative embodiment of an elastic tie-down strap with snap hooks for attaching tire chains to a tire according to the present invention.

Similar reference characters denote corresponding features consistently throughout the attached drawings.

### DETAILED DESCRIPTION OF THE PREFERRED EMBODIMENTS

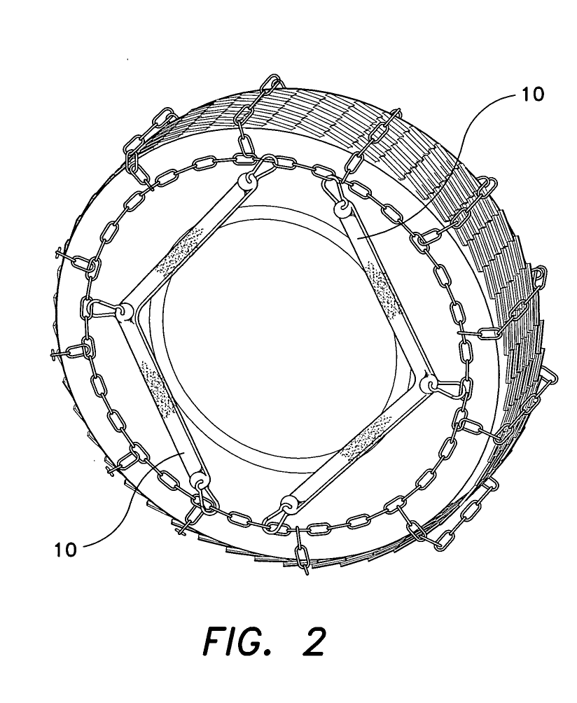

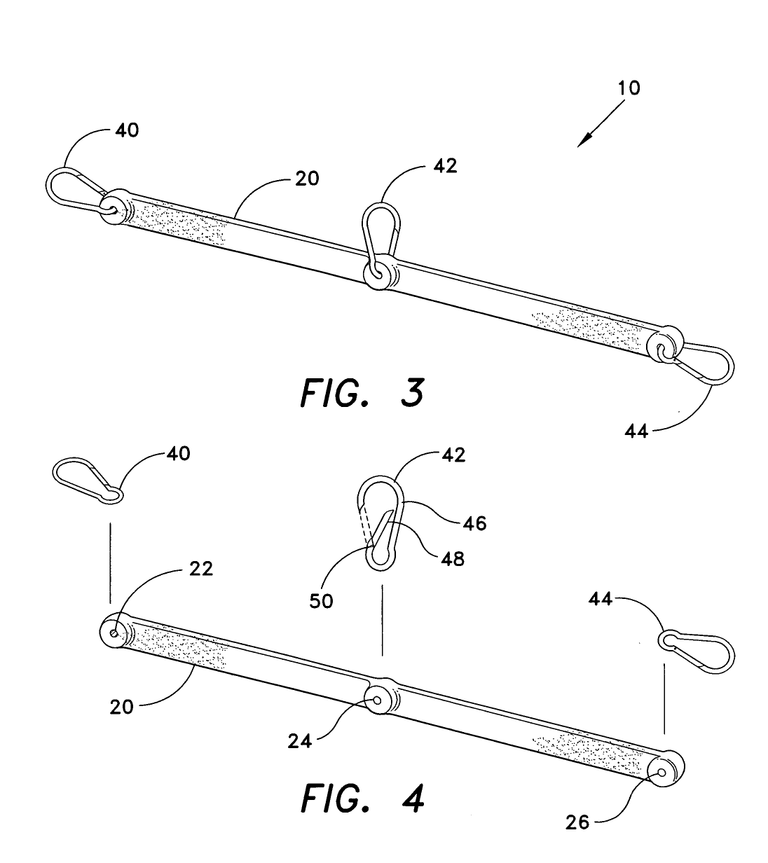

The present invention is an elastic tie-down strap with snap hooks for attaching tire chains to tires, designated generally as 10 in the drawings. As shown in FIGS. 2 through 5B, the device has a substantially flat, elongated, elastic member 20 with three holes 22, 24 and 26 passing through it and a snap hook 40, 42 and 44 coupled with it 20 via each of the holes 22, 24 and 26.

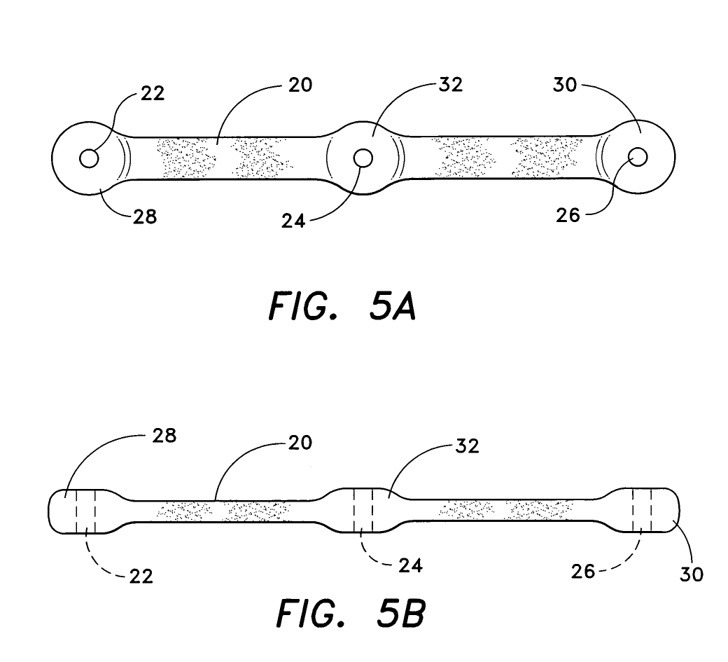

One of the holes 22 is located at the first end 28 of the elongated elastic member 20. Another hole 26 is located at the second end 30, and the third hole 24 is located between the first and second ends 28 and 30. A reinforced area 28, 30 and 32 is formed around each of the three holes 22, 24 and 26. Each reinforced area 28, 30 and 32 is substantially cylindrical, as shown in FIGS. 5A and 5B, with one of the holes passing coaxially though it 28, 30 and 32.

The three snap hooks 40, 42 and 44 are self-locking hooks, generically known as carabineers and are commercially available, for example, under the non-trademarked product name “Spring Link” by a business entity doing business as the Lehigh Group. Each snap hook 40, 42 and 44 is a key-hole shaped loop with a main member 46 and a resilient pivoting arm 48 that is capable of pivoting between an open position and a closed position, as shown in FIG. 4. The pivoting arm 48 pivots on a spring pin 50 that normally biases the pivoting arm 48 in the closed position, and is moved into an open position by finger pressure.

The elongated elastic member 20 is preferably constructed of rubber.

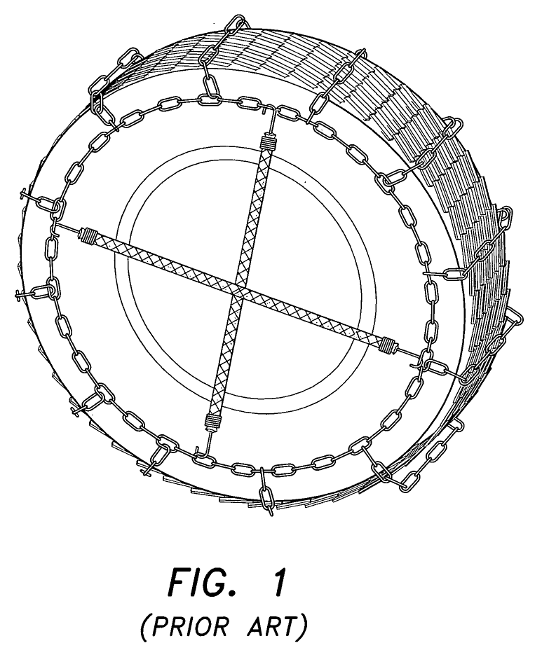

As shown in FIG. 2, when a pair of the device 10 are attached to six points on a set of tire chains that is wrapped around a tire such that each elongated elastic member forms a two-legged angle with each leg stretched and in tension, the devices 10 secure the set of tire chains tightly to the tire. Significantly, the devices 10 do not cross over each other thereby avoiding the chafing associated with prior art elastic members, shown in FIG. 1, and reducing the likelihood of breakage. Furthermore, in the event of breakage, the fragments of each 10 of the devices remain attached to the snap hooks which remain attached to the tire chains and, thus, neither litter roadways nor present a danger of injury to persons by snapping free from a tire chain. Moreover, by incorporating self-locking snap hooks 40, 42 and 44, the devices 10 are less likely to be inadvertently unhooked and snap off of a tire.

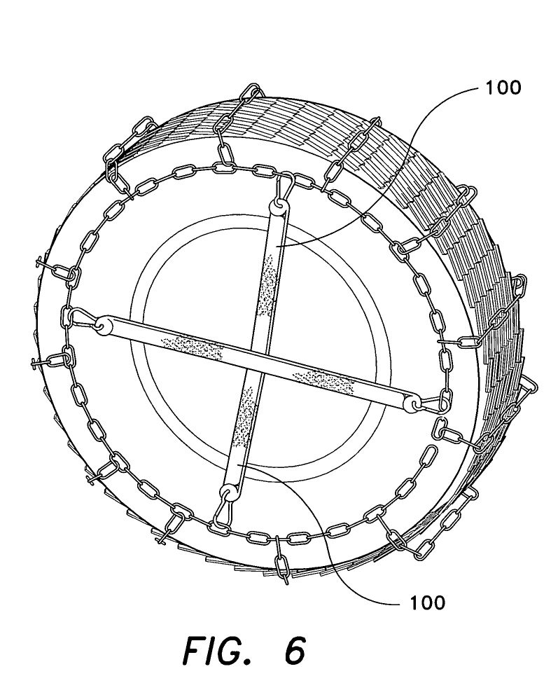

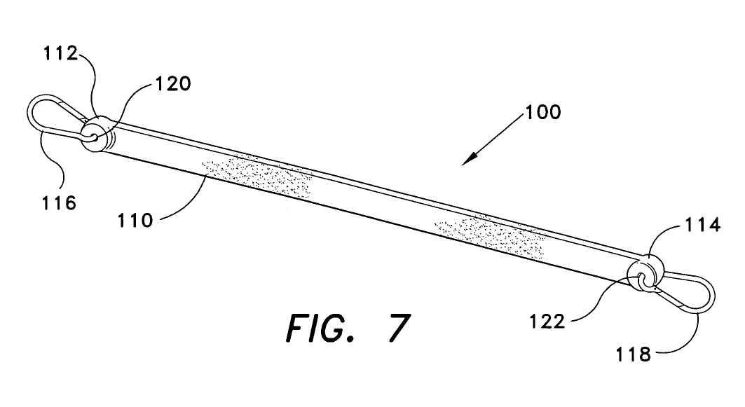

In an alternative embodiment, the elastic tie-down 100, shown in FIGS. 6 and 7, is an elongated elastic member 110 having just two holes 120 and 122, one in each of its two ends 112 and 114 with a snap hook 116 and 118 passing through each hole 120 and 122.

In either of the abovementioned elastic tie-downs 10 and 100, the elongated elastic member can also be substantially cylindrical.

It is to be understood that the present invention is not limited to the embodiments described above, but encompasses any and all embodiments within the scope of the following claims.

1. An elastic tie-down strap with snap hooks for attaching tire chains to tires, comprising:
an elongated elastic member having a first end, a second end, and a segment extending between said first end and said second end;
a first snap hook attached to the first end of the elastic member;
a second snap hook attached to the second end of the elastic member; and
a third snap hook attached to the segment of the elastic member between the first and second ends;
whereby, when the first, second and third snap hooks are attached to three points on an inner circular portion of the tire chains, the elastic member secures the tire chains to the tire.

2. The elastic tie-down strap according to claim 1, wherein said elongated elastic member is substantially flat.

3. The elastic tie-down strap according to claim 1, wherein said elongated elastic member is substantially cylindrical.

4. The elastic tie-down strap according to claim 1, wherein said elongated elastic member is constructed of rubber.

5. The elastic tie-down strap according to claim 1, wherein each of said first and second snap hooks is self-locking.

6. The elastic tie-down strap according to claim 1, wherein each of said first and second snap hooks is a carabineer.

7. An elastic tie-down strap with snap hooks for attaching tire chains to tires, comprising:
an elongated elastic member having a first end and a second end;
a first snap hook attached to the first end of the elastic member; and
a second snap hook attached to the second end of the el astic member;
whereby, when the first and second snap hooks are attached to two opposing points on an inner circular portion of the tire chains, the elastic member secures the tire chains to the tire.

8. The elastic tie-down strap according to claim 7, wherein said elastic member is substantially flat.

9. The elastic tie-down strap according to claim 7, wherein said elastic member is substantially cylindrical.

10. The elastic tie-down strap according to claim 7, wherein said elastic member is constructed of rubber.

11. The elastic tie-down strap according to claim 7, wherein each of said first and second snap hooks is self-locking.

12. The elastic tie-down strap according to claim 7, wherein each of said first and second snap hooks is a carabineer.
